(19) United States
(12) Patent Application Publication
(10) Pub. No.: US 2013/0305657 A1
(43) Pub. Date: Nov. 21, 2013

(54) Deformable guide for partitions in general

(71) Applicant: Nicola Ceccato, Battaglia Terme - Padova (IT)

(72) Inventor: Nicola Ceccato, Battaglia Terme - Padova (IT)

(21) Appl. No.: 13/981,389

(22) PCT Filed: Apr. 13, 2011
(86) PCT No.: PCT/IB2011/051597

§ 371 Date: Aug. 5, 2013

(30) Foreign Application Priority Data
Feb. 10, 2011 (IT) PD2011A000040

(51) Int. Cl. E04C 3/00; E05D 15/06

(52) U.S. Cl. CPC E04C 3/00; E05D 15/0652
USPC 52/846

(57) ABSTRACT

A deformable guide for partitions in general includes a plate strip that is die cut, cut and bent to form a U and that has continuous sections alternating with sections provided with cuts and holes. Each section with cuts and holes is provided at least with cuts and holes that are orthogonal to the edge of the plate strip and suited to divide such section into portions, wherein those portions are bent with respect to each other to form a 115° angle.

### FIELD OF THE INVENTION

The present patent concerns the field of wall construction with prefabricated panels applied to a light bearing structure, and in particular it concerns a new type of section bar for making light bearing structures on which prefabricated panels can be applied and fixed.

### BACKGROUND OF THE INVENTION

At present metallic structures supporting panels in plasterboard or other similar materials are widely used for making partitions or furnishing walls. Said structures are easy and quick to make and allow walls to be obtained that have special or arched shapes that are otherwise expensive and difficult to obtain with bricks and cement.

Rectilinear walls or partitions can be made with plasterboard panels applied to a frame of rectilinear elements in wood or metal section bars.

If the walls are not rectilinear, deformable guides are used that are constituted by a die cut and bent plate so as to form a continuous assembly of modular box-shaped elements.

A plate strip is substantially die cut and bent in the shape of a U so as to form a series of U-shaped segments joined to one another by three projections, two on the sides and one on the bottom. Successively, the projections are bent inside the “U” shape until obtaining a series of box-shaped elements without one of the large surfaces and joined to one another through portions of the small surfaces.

In the construction stage each deformable guide is used as it is or is adapted to the curvilinear shape to be obtained, by unfolding the bent projections. Said deformable guides, however, pose a series of drawbacks:

the limited width of the U-shaped elements makes them incompatible with most of the similar but rectilinear structures that must converge in the curved portions and be integrated with them, without complex and precarious adaptations;

the presence of the projections bent inwards prevents the longitudinal sliding movement in the correct position of the vertical upright plate section bars that make up the supporting frame of the panels in plasterboard or similar materials;

the presence of the projections bent inwards makes it impossible to use them as a seat for a recessed sliding door;

the risk that the fixing screws of the plasterboard or external objects or structures may correspond to the die cut holes present in the articulated element makes said fixing insecure.

### SUMMARY OF THE INVENTION

To remedy all the above mentioned drawbacks a new type of deformable guide has been designed and constructed.

The new deformable guide is made up of a plate strip that is die cut and bent so as to take the form of a U-shaped profile.

The metal strip is die cut and holed so as to obtain continuous sections alternating with sections having cuts and holes.

Each section with cuts and holes is provided with cuts on the side bands and the center band.

In particular:

each side band is provided with three cuts parallel to one another and perpendicular to the edge of the strip;

the centre area is provided with two cuts, parallel to each other and aligned with the external cuts present on the side bands;

two holes with five sides, of which three sides are orthogonal to one another and arranged in the area included between the side bands and the center band, while two sides are inclined with respect to each other and to the other sides with the vertex included between them facing towards the centre of the center area.

The side bands or edges of the strip are then bent orthogonally to the center band or area of the strip so as to form a section bar with U-shaped profile. Consequently, the portion of each five-sided hole having three orthogonal sides comes to be positioned in the side wall of the U-shaped section while the other portion with angled vertex of each hole comes to be positioned in the center bottom wall of said U-shaped profile of the section bar.

The areas with cuts are pre-bent towards the inside of the “U” shape, so that each portion included between two parallel cuts, both of the side walls and of the bottom wall of the U-shaped profile, faces towards the inside of the U-shaped profile of the section bar.

In particular, said areas with cuts are pre-bent towards the inside of the “U” shape so that the portions included between two parallel cuts form a 115° angle.

The deformable guide made up as described makes it possible to obtain, with the aid of plasterboard panels, linear or arched walls or false ceilings. The new deformable guide is used as it is for linear structures. It can serve as a guide for a sliding door or a recessed door inside the wall made with the new deformable guide and plasterboard panels.

If it is necessary to make partitions, walls, false ceilings or other curved structures it is possible to shape the new deformable guide by properly bending the portions provided with cuts. The new deformable guide can be curved both laterally, so that the base of the U-shaped profile always lies on one plane, and vertically, so that all the wings of the U-shaped profile of the structural elements lie on two parallel planes.

In any case, when fixing elements such as screws or bolts are applied, there is always a portion of the wall of the new deformable guide that guarantees suitable and adequate resistance.

Furthermore, during assembly, the new deformable guide makes it possible to lay easily and quickly the upright section bars in galvanized steel that make up the supporting frame of the panels in plasterboard or similar materials and to slide said upright section bars until reaching the fixing point.

Therefore, the new deformable guide considerably simplifies the assembly operations, thus reducing the time needed for the installation of the walls and false ceilings produced in this way.

### BRIEF DESCRIPTION OF THE DRAWING

The attached drawing shows, by way of non-limiting example, a practical embodiment of the invention.

FIG. 1 shows the development of the new deformable guide, that is, the die cut plate strip before bending.

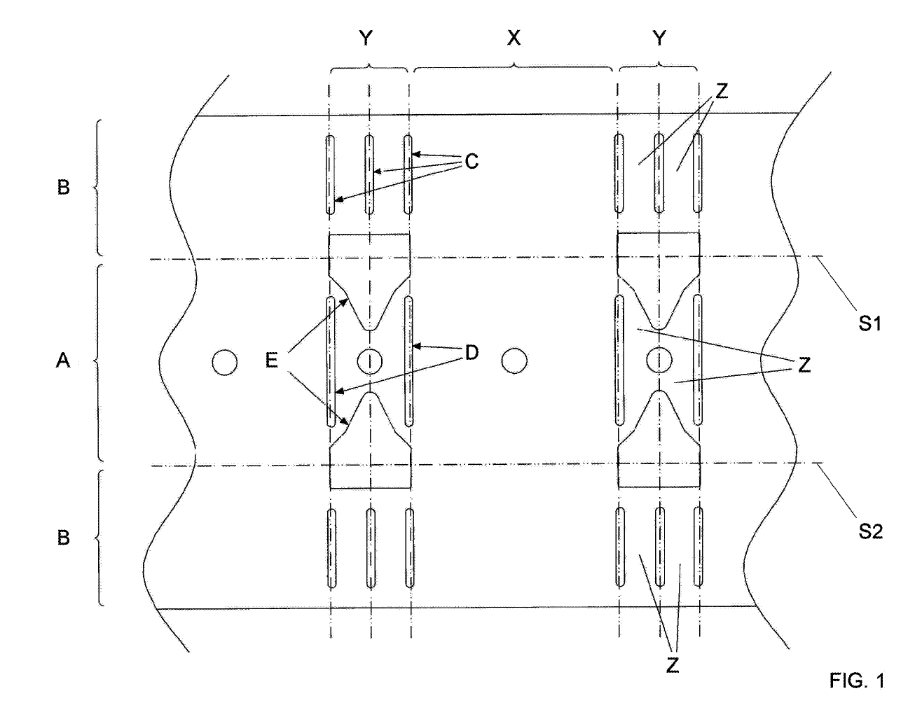

FIGS. 2a and 2b show a side view and a top view of a section bar according to the invention, formed by the center band and the side bands bent to form a U-shaped profile.

### DETAILED DESCRIPTION OF EMBODIMENTS OF THE INVENTION

A metal strip according to the invention is provided with areas (X) without gaps alternating to areas (Y) with cuts and die cuts.

The folding lines (S1, S2) are indicated by dash-point lines.

The plate strip comprises a center band (A) and two side bands or edges (B).

Each side band (B), with respect to the area (Y) with cuts, is provided with three cuts (C) that are parallel to one another and perpendicular to the edge of the plate strip.

Each center band (A), with respect to the area (Y) with cuts, is provided with two cuts (D) that are parallel to each other and aligned with the external cuts (C) present on the side bands (B).

There are two holes (E) with five sides, of which three sides are orthogonal to one another and arranged in the area included between the side bands (B) and the centre band (A), and two sides are inclined with respect to each other and to the other sides with the vertex included between them facing towards the centre of the central area (A).

The strip is then bent along the folding lines (S1, S2) forming a U-shaped section bar.

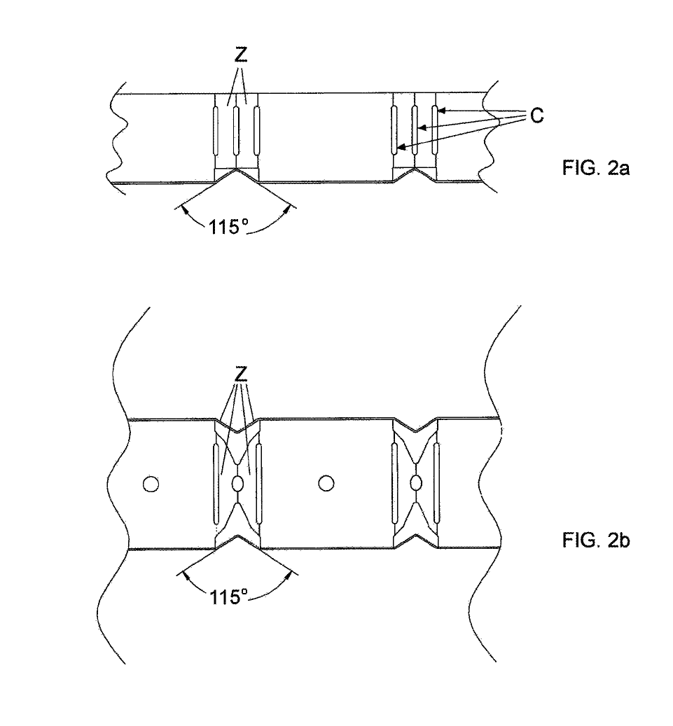

FIGS. 2a and 2b show a side view and a top view of a section bar according to the invention, formed by the center band (A) and the side bands (B) bent so as to form a U-shaped profile.

The areas (Y) with cuts (C, D, E) are pre-bent towards the inside of the “U” shape, so that each portion (Z) included between two parallel cuts (C, D), both of the side walls (B) and of the bottom wall (A) of the U-shaped profile, faces towards the inside of the U-shaped profile of the section bar. In particular, said areas (Y) with cuts (C, D, E) are pre-bent towards the inside of the “U” shape so that the portions (Z) included between two parallel cuts (C, D) form a 115° angle.

Therefore, with reference to the above description and the attached drawing, the following claims are expressed.

The invention claimed is:

1. A deformable guide for partitions in general, comprising:
a plate strip that is die cut, cut and bent to form a U shape in a longitudinal direction, and has first transversal sections alternating with second transversal sections having transversal slots therein,
wherein each second transversal section is provided at least with transversal slots that are orthogonal to an edge of the plate strip and configured to divide said second transversal section into portions, and
wherein said portions are bent to have walls forming a 115° angle in relation to the longitudinal direction of the plate strip.

2. The deformable guide according to claim 1, wherein each second transversal section of the U shape is provided with three transversal slots disposed on side bands of the U shape that are parallel to each other and orthogonal to the edge of the plate strip.

3. The deformable guide according to claim 2, wherein each second transversal section is provided with two transversal slots disposed in a central part of the U shape that are parallel to each other and aligned with the outermost transversal slots in the side bands of the U shape, and wherein said central part is provided with two holes with five sides, of which three sides are orthogonal to each other and arranged in an area included between the side bands and the central part of the U shape, and two sides are inclined with respect to each other and to the three sides, the two sides meeting at a vertex facing towards a center of the central part.
